(19) United States
(12) Patent Application Publication
(10) Pub. No.: US 2007/0018130 A1
(43) Pub. Date: Jan. 25, 2007

(54) Ceramic valve for antifreezing faucets

(76) Inventor: Hung-Nang Wu, Lugang Township (TW)

Correspondence Address: TROXELL LAW OFFICE PLLC, SUITE 1404, 5205 LEESBURG PIKE, FALLS CHURCH, VA, 22041, US

(21) Appl. No.: 11/184,886

(22) Filed: Jul. 20, 2005

(51) Int. Cl. F16K 5/10

(52) U.S. Cl. 251/208

(57) ABSTRACT

A ceramic valve for antifreezing faucets including a straight water supply pipe, a shaft base installed in an upper section of a main body of the water supply pipe and connected to a down connecting rod at a lower section, and a double-plate ceramic intake valve. Wherein the connecting rod is interlinked at the lower part by a rotary pivot bolt at a bottom for positioning and controlling an alignment of water outlets of both top and bottom ceramic valve plates, so as to open or shut off water and regulate water volume. The double-plate ceramic intake valve includes disc-shaped top and bottom ceramic valve plates. A side of the top ceramic valve plate has some symmetrical position grooves engaged with concave buckling of symmetrical hack levers of the connecting rod.

### BACKGROUND OF THE INVENTION

1) Field of the Invention

The present invention relates to an improved ceramic valve for antifreezing faucets, in which a pair of double-plate ceramic intake valves, including disc-shaped top and bottom ceramic valve plates with some maximal big semicircular effluent holes, are designed. And the side of bottom section of a shaft bolt extends downwards to form a pair of symmetrical hack levers whose inside bottom has a concaved buckling part, so as to form linked control with the symmetrical position groove at the side of top ceramic valve plate; in addition, because the upper section of the hack levers is hollow-out and both sides form a wide and open effluent part, the effects of augmented effluent water and reduced block can be obtained, that is, it can ease the water's freezing and block at the water intake.

2) Description of the Prior Art

Generally, the conventional antifreezing faucet for outside ground mainly is designed and installed for outdoors water getting and watering conveniently. Nevertheless, the conventional antifreezing faucet (as shown in FIG. 1) is composed of a straight water supply pipe 21, a shaft base 22 installed at the upper section of the main body of water supply pipe 21 and connected to a down connecting rod 23 at the lower section, and a double-plate ceramic intake valve. Wherein the connecting rod 23 is interlinked at the lower part by a rotary pivot bolt 24 at its bottom for positioning to control the alignment degree of the water outlets of both top and bottom ceramic valve plates 251, 252) and to open or shut off the water, and regulate its volume; in which, the bottom ceramic valve plate 252 of the double-plate ceramic intake valve is separated at a 90-degree angle to form two symmetrical effluent holes 2521 with ¼ circular diameter, further under the disc, two symmetrical concaved butterfly top ceramic valve plates 251 are formed for water outlet in order to make the water W from the lower part can be refractable and supplied before the effluent holes 2521 of the bottom ceramic valve plate 252 are sheltered by the top ceramic valve plate 251 (as shown in FIG. 1-A).

Because of the foregoing ceramic valve's small effluent holes 2521, that is, only ¼ circular diameter, the effluent water W is limited. It fails to meet the demands for a large amount of water or high flow in the case of sprinkling large area and further places; particularly, in the frigid zone or some areas where the water easily freezes for the low temperature in the winter, it is easier that the water W will freeze at the small effluent holes 2521, more seriously block the faucet, accordingly, that will cause inconvenience and make waste. Therefore, this problem should be solved.

### SUMMARY OF THE INVENTION

The main purpose of the present invention is to provide an improved ceramic valve for antifreezing faucets, in which a pair of double-plate ceramic intake valves, including disc-shaped top and bottom ceramic valve plates with some maximal big semicircular effluent holes, are designed. And the side of bottom section of a shaft bolt extends downwards to form a pair of symmetrical hack levers whose inside bottom has a concaved buckling part, so as to form linked control with the symmetrical position groove at the side of top ceramic valve plate; in addition, because the upper section of the hack levers is hollow-out and both sides form a wide and open effluent part, the effects of augmented effluent water and reduced block can be obtained, that is, it can ease the water's freezing and block at the water intake.

Another purpose of the present invention is still to provide an improved ceramic valve for antifreezing faucets, which is to be designed as a double-plate ceramic intake valve comprising equal disc-shaped top and bottom ceramic valve plates. It can reduce difficulties in manufacturing the valve and improve preparation precision. In addition, because the surface of the two ceramic discs is even, it can supply or shut off water stably.

### BRIEF DESCRIPTION OF THE DRAWINGS

FIG. 1: The three-dimensional exploded view of the prior invention.

FIG. 1-A: The cutaway view of the prior invention.

FIG. 2: The three-dimensional exploded view of the embodiment in accordance with the present invention.

FIG. 3: The three-dimensional combination view of the embodiment in accordance with the present invention.

FIG. 4: The cutaway view of the embodiment in accordance with the present invention.

FIG. 4-A: The illustration of overall water-out of top and bottom ceramic valve plates under complete alignment.

FIG. 4-B: The illustration of partial water-out of top and bottom ceramic valve plates under partial alignment.

FIG. 4-C: The drawing for illustrating that the present invention shuts off water when the top and bottom valve plates do not align with the effluent holes completely.

FIG. 4-D: The amplified cutaway view of combined shaft bolt and top and bottom valve plates.

FIG. 4-E: The cutaway view of another side of FIG. 4-D as reference.

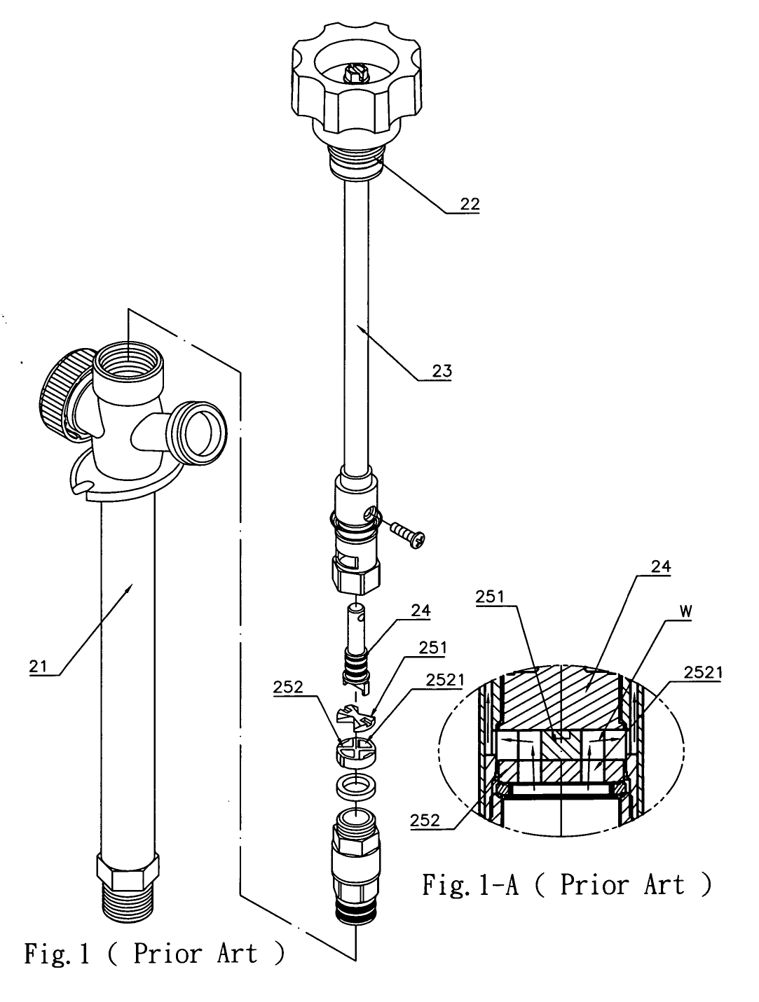

### DETAILED DESCRIPTION OF THE PREFERRED EMBODIMENTS

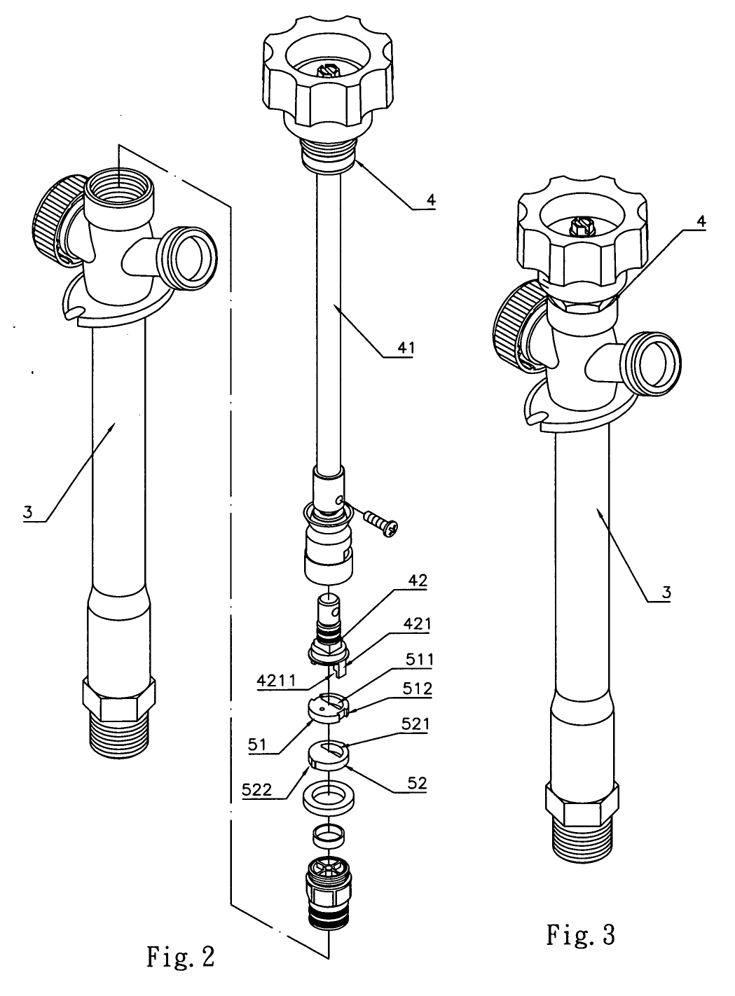

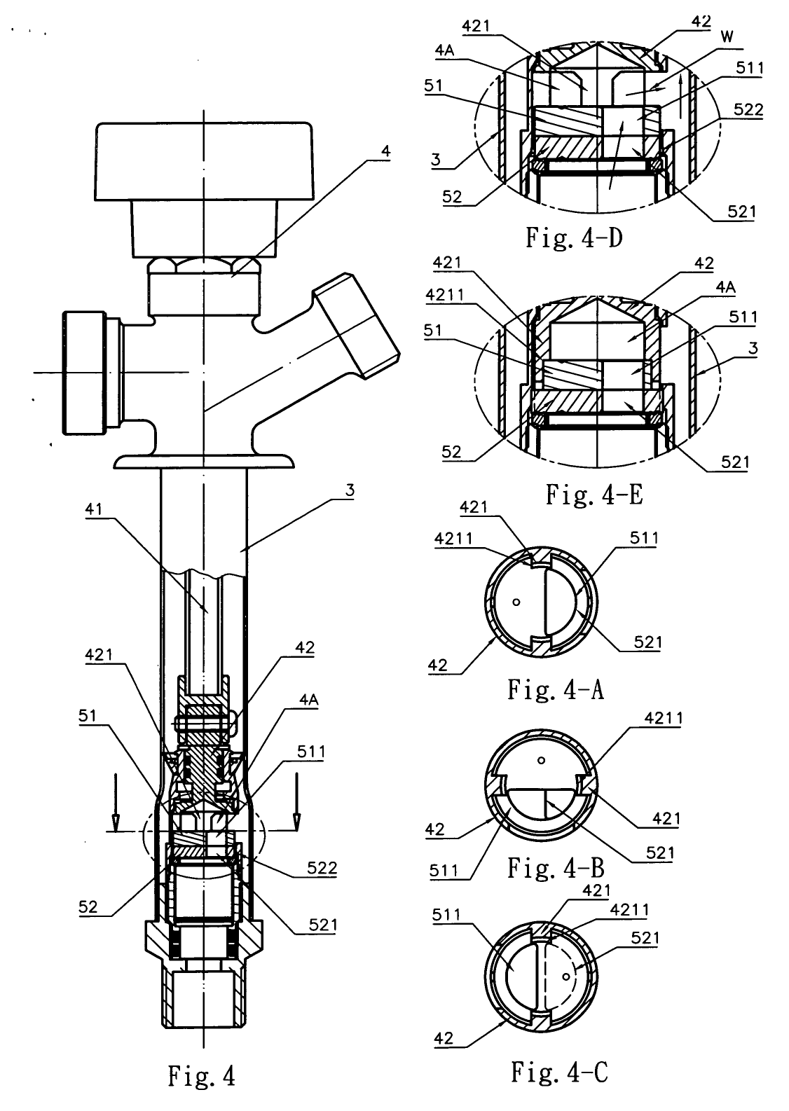

Referring to FIG. 2˜FIG. 4, more details on application of the present invention and embodiments are described upon icons as follows: the present invention mainly is composed of a straight water supply pipe 3, a shaft base 4 installed at the upper section of the main body of water supply pipe 3 and connected to a down connecting rod 41 at the lower section, and a double-plate ceramic intake valve. Wherein the connecting rod 41 is interlinked at the lower part by a rotary pivot bolt 42 at its bottom for positioning to control the alignment degree of the water outlets 511, 512 of both top and bottom ceramic valve plates 51 and 52. It features:

Both the top and bottom ceramic valve plates 51 and 52 of the intake ceramic valve are equal disc-type ceramic valve, on which the maximal semicircular effluent holes 511, 521 are designed, so as to conduct the overall alignment (as shown in FIG. 4-A), partial alignment (as shown in FIG. -B) and staggered alignment regulation (as shown in FIG. 4-C) to set it under full, partial effluent or shut-off control modes; in addition, when bottom ceramic valve plate 52 is interlinked at the inside bottom section of the main body of the water supply pipe, some position protruding points 522 at its side may be embedded into the concaved points at the symmetrical point to form rotary braking. And a symmetrical position groove 512 is available at the side of the top ceramic valve plate 51; and

The side of bottom section of the shaft bolt extends downwards to form a pair of symmetrical hack levers 421; in which the inside bottom 421 of the hack levers 421 has a concaved buckling part 4211 respectively, which may be embedded into the position groove 512 at the side of top ceramic valve plate 51 to form linked control, further the upper side of the top ceramic valve plate 51 is hollow-out and both sides form wide and open an effluent part 4A while finishing the combination of the upper section of the hack levers 421 (please refer to FIG. 4-D and E); and during the alignment effluent regulation the water W can go through the effluent part 4A vertically with the effluent holes 511, 521 on the top and bottom ceramic valve plates 51, and turn to the internal wall of the main body 3 of the water supply pipe and supply upwards and outwards.

Moreover, because of big semicircular effluent holes 511 and 521 designed on the top and bottom ceramic valve plates 51, 52 and the big open effluent part 4A at the top side, the effects of augmented effluent water and reduced block would be obtained, so as to effectively prevent block for the frozen water at the water intake and enhance its antifreezing function actively.

1. (canceled)

2. A ceramic valve for an antifreeze faucet comprising:
a) a straight water supply pipe;
b) a shaft base having:
I) a connecting rod extending downwardly therefrom, the connecting rod is inserted into an interior of the straight water pipe; and
ii) a rotary pivot bolt connected to the connecting rod and having two symmetrical hack levers located on a bottom end thereof;
c) a top ceramic valve plate movable between open and closed positions and having a first semicircular effluent through hole and two positioning grooves, one of the two symmetrical hack levers is inserted into each of the two positioning grooves, the first semicircular effluent through hole has a first straight wall and a first curved wall having opposing ends directly connected to opposing end of the first straight wall; and
d) a bottom ceramic valve plate located below the top ceramic valve plate and having a second semicircular effluent through hole, the second semicircular effluent through hole has a second straight wall and a second curved wall having opposing ends directly connected to opposing end of the second straight wall,
wherein, when the top ceramic valve plate is located in the open position, the first semicircular effluent through hole aligning with the second semicircular effluent through hole, the second semicircular effluent through hole communicating with the interior of the straight water pipe through the first semicircular effluent through hole, and when the top ceramic valve plate is located in the closed position, the first semicircular effluent through hole is rotated to a position spaced apart from the second semicircular effluent through hole, the second semicircular effluent through hole is prevented from communicating with the interior of the straight water pipe by the first semicircular effluent through hole.

3. The ceramic valve according to claim 2, wherein the two positioning grooves are located on opposing sides of the top ceramic valve plate.

4. The ceramic valve according to claim 2, wherein the second semicircular effluent through hole of the bottom ceramic valve plate has two protruding points extending outwardly.

5. The ceramic valve according to claim 4, wherein the two protruding points preventing rotation of the bottom ceramic valve plate.

6. The ceramic valve according to claim 2, wherein each of the two symmetrical hack levers has a concave buckling part.

7. The ceramic valve according to claim 2, wherein each of the two positioning grooves communicating with a top and a bottom of the top ceramic valve plate.
